(19) United States
(12) Patent Application Publication
(10) Pub. No.: US 2003/0041490 A1
(43) Pub. Date: Mar. 6, 2003

(54) Compact assembly for circulating artificial snow particles

(76) Inventors: Harper Glenn Dott, Monterey Park, CA (US); Yung Sun Kwan, Chai Wan (HK)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/945,060

(22) Filed: Aug. 31, 2001

(51) Int. Cl. G09F 19/00; G09F 19/08

(52) U.S. Cl. 40/410; 40/412

(57) ABSTRACT

According to an embodiment, the apparatus includes a conduit, a base assembly, and a drum. The base assembly has a blower unit to create suction at openings of a tube that is coupled to the conduit. The blower unit has sufficient strength so that particles can be sucked into the tube and then blown through the conduit past a distal opening of the conduit, while the conduit is vertically oriented such as a Christmas tree on display. The base assembly has a first catch that extends away from and surrounds the tube openings. The drum has a number of connected sections where each can pivot with respect to adjacent ones so that the sections can be folded on top of each other to form a stack. Each upper portion of the section has a fastening mechanism which allows upper portions to be removably attached to the portions of adjacent sections so as to form another catch that has an opening. When the drum is positioned over the base assembly, the catch opening is located above and substantially coaxial with the first catch.

### BACKGROUND

The invention is generally related to assemblies that produce an artificial snowfall effect such as one that surrounds an artificial Christmas tree.

Previously proposed arrangements for creating artificial snowfall have been relatively complex and bulky structures that may be too expensive for mass production. For instance, U.S. Pat. No. 5,412,888 to Rickus et al. shows an assembly for producing artificial snowfall in a Christmas tree display arrangement that is stored as a pack. This arrangement is useful for creating an artificial snowfall effect on an actual Christmas tree. U.S. Pat. No. 4,962,922 also shows an apparatus for circulating artificial snow, for use with an actual Christmas tree. In. U.S. Pat. No. 4,028,830 to Ottinger, a fixture for simulating falling snow is disclosed in which a riser pipe extends centrally through a trunk of an artificial tree, with branches attached to the trunk. In view of these prior arrangements, there is a need for a more cost effective assembly that can automatically circulate artificial snow particles.

### BRIEF DESCRIPTION OF THE DRAWINGS

The invention is illustrated by way of example and not by way of limitation in the figures of the accompanying drawings in which like references indicate similar elements. It should be noted that references to “an embodiment” in this disclosure are not necessarily to the same embodiment, and they mean at least one.

FIG. 1 shows a packing box which contains an artificial tree together with a base assembly for the tree and a drum that has been folded into a stack, according to an embodiment of the invention.

FIG. 2 shows an embodiment of an upper conduit portion that is formed into part of the artificial tree.

FIG. 3 shows a cross section view of the upper conduit portion in FIG. 2.

FIG. 4 depicts a perspective view of an embodiment of the lower conduit portion that is used to form the artificial tree.

FIG. 5 shows a side view combined with a cross section view of the lower conduit portion illustrating how the branches of the artificial tree may be connected to the outer surface of the conduit portion.

FIG. 6 shows an embodiment of a conduit that comprises at least two portions, namely an upper portion that is fitted into the top of a lower portion.

FIG. 7 illustrates a cross section of the base assembly showing a blower unit being coupled to the conduit.

FIG. 8 illustrates a top view of the drum in its unfolded position.

FIG. 9 shows the drum partially assembled to form part of a catch.

FIG. 10 shows a perspective view of an embodiment of the artificial snowfall circulating apparatus.

### DETAILED DESCRIPTION

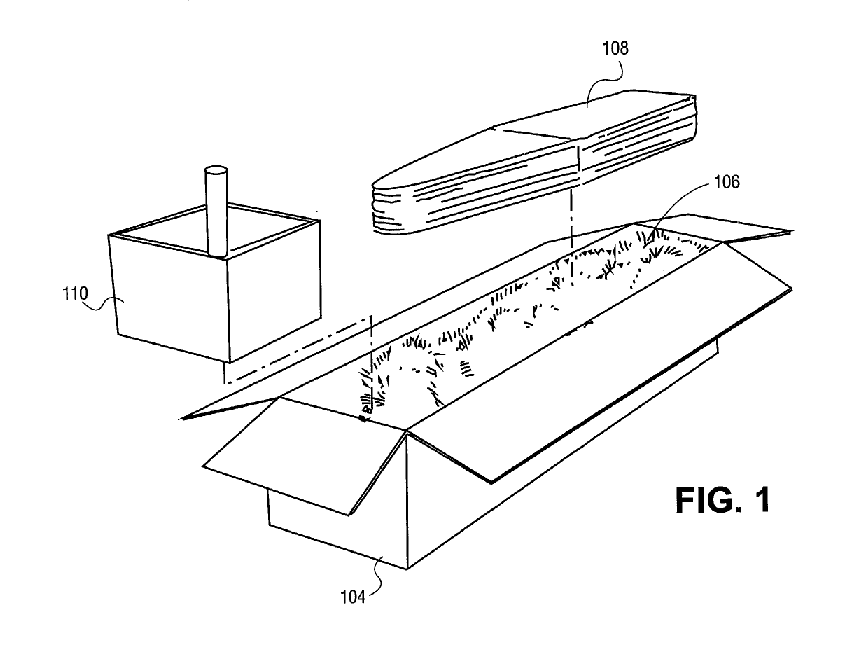

According to an embodiment of the invention, a compact artificial snow circulating apparatus is described which can be efficiently packed for shipment. In addition, the apparatus can be easily deployed into its operational state. Referring now to the embodiment of FIG. 1, a shipping box 104 is shown that contains a collapsed artificial tree 106. A drum 108, also in collapsed form in which its sections are folded on top of each other to form a stack, fits inside the shipping box 104. A base assembly 110 that contains a blower unit for blowing the artificial snow particles through the artificial tree is also provided as part of the apparatus. Each of these elements will be described according to its various embodiments below.

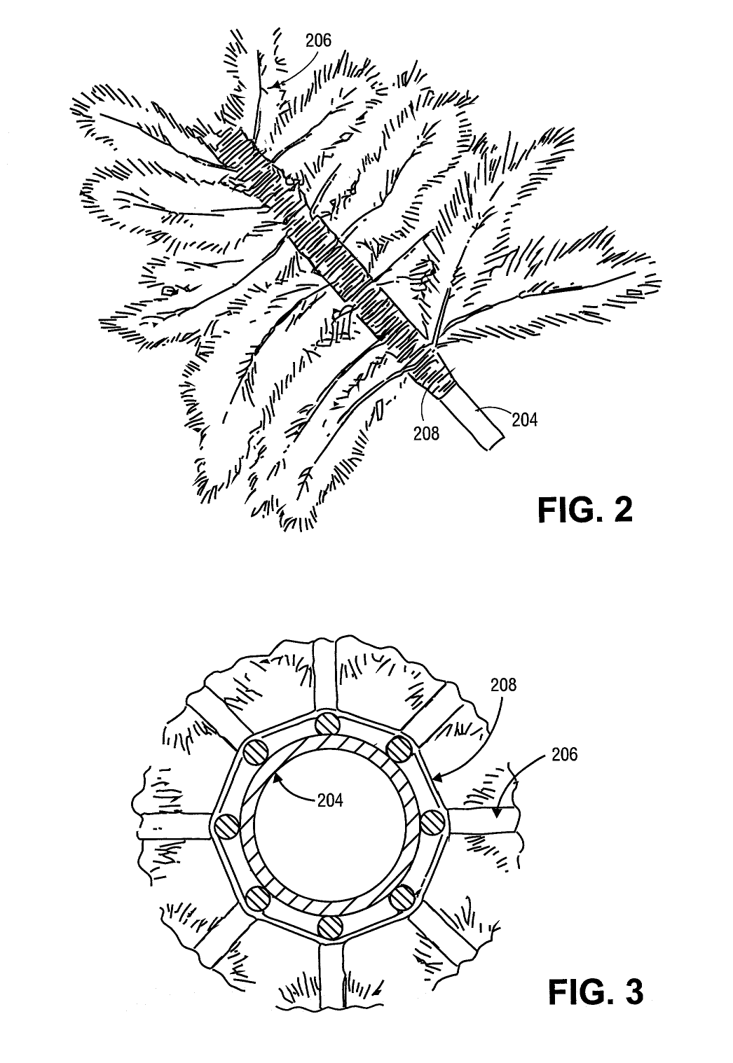

Referring now to FIG. 2, a portion of an embodiment of the artificial tree is shown. This artificial tree portion is formed around an upper conduit portion 204 through which the artificial snow particles will be blown and which makes up the top half of the tree. Decorative elements, in this case artificial tree branches are attached directly to the outer surface of the wall of the conduit portion 204.

FIG. 3 shows an exemplary technique for attaching the decorative elements to the outside wall of the upper conduit portion 204. Each decorative element has an end portion that is held against the outer surface of the wall of the upper conduit portion 204 by, in this embodiment, tape that is wound a number of times around each end. By winding the tape around the upper conduit portion 204 as shown in FIG. 2, the appearance of a tree trunk is created without a separate trunk that acts as a sleeve around the conduit portion, while at the same time giving the appearance that tree branches are connected to a trunk (see FIG. 2). In other words, the conduit is coaxial with the trunk of an artificial tree and acts as both the trunk and the passage for blowing snow particles up to the top of the tree. This permits a less costly yet aesthetically pleasing solution to an artificial Christmas tree snowing apparatus.

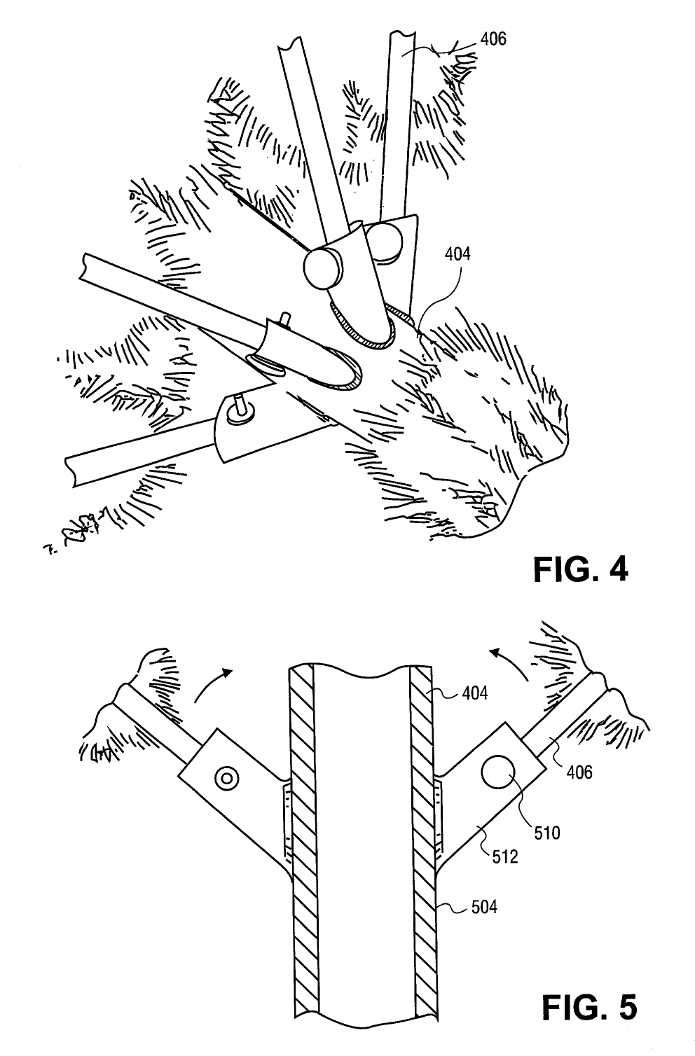

The artificial tree 106 may also have a lower half that has decorative elements 406 attached to the outer surface of a lower conduit portion 404 shown in FIG. 4. The decorative elements 406 are directly attached to the outer surface of the lower conduit portion 404. These larger decorative elements 406 may have the appearance of larger tree branches than those that are attached to the upper conduit portion 204 (see FIG. 2). FIG. 5 shows a side view of the lower conduit portion 404 and an embodiment of an attachment mechanism for attaching the decorative element 406 to the outer surface 504 of the lower conduit portion 404. The decorative element 406 has an end 510 that is pivotally coupled to a base 512, so that the element 406 can be pivoted from an open or outwardly position (as shown) to a closed position that is more suitable for packing. The base 512 is directly attached to the outer surface 504, in this embodiment, by a welding procedure. In this embodiment, both the lower conduit portion 404 and the base 512 are made of metal. Note that the use of metal for both conduit portions 404 and 204 may help reduce the creation of static electricity as the artificial snow particles which may be made of plastic are blown through the conduit. This reduction in the creation of static electricity will help the artificial snow particles to move more freely through the conduit portions and to fall more freely downwards through the artificial tree branches.

Referring to FIG. 5, the decorative element 406 may be pivoted in the direction of the arrow shown such that it lies more closely against the conduit portion 404 when the artificial tree is about to be placed into its shipment box. This makes the artificial tree more compact, for easier storage inside the shipment box. When the artificial tree is on display and operating, the decorative elements 406 are rotated back to their open position as shown in FIG. 5 thereby simulating the branches of a Christmas tree.

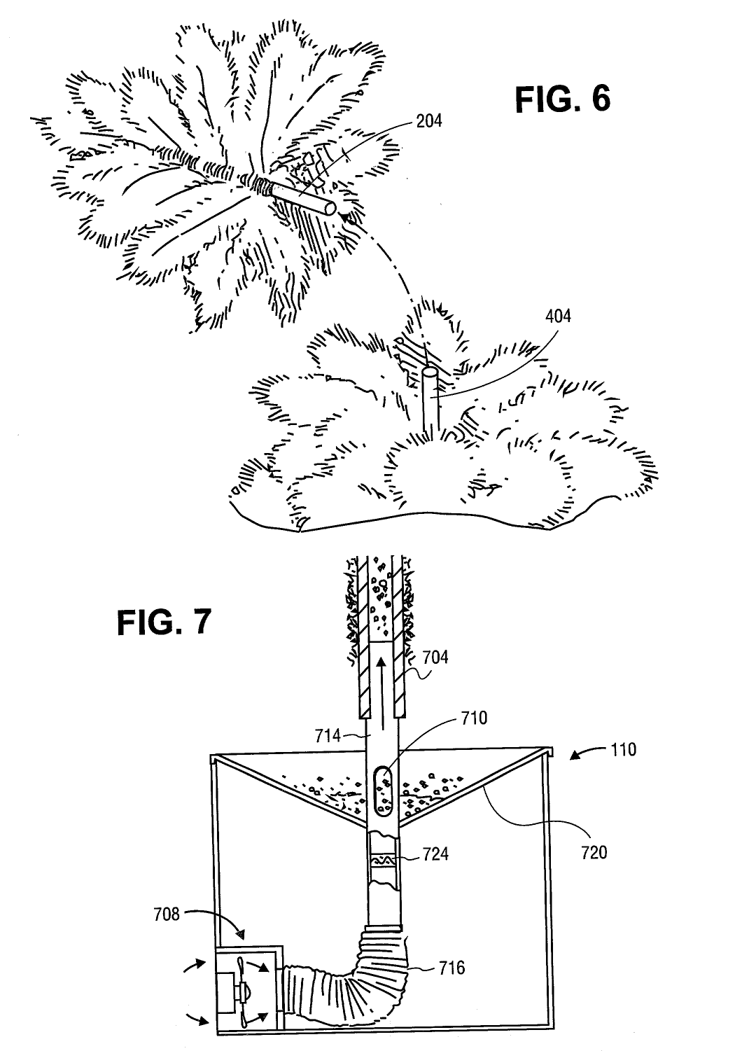

Referring now to FIG. 6, what's shown is a technique for assembling an embodiment of the artificial tree, by inserting an open proximal end of the upper conduit portion 204 into an open distal end of the lower conduit 404. The artificial tree may, alternatively, have a one-piece conduit that has the artificial branches attached to its outer surface in the manner described above, or it may have more than two portions, depending upon the desired size of the tree and the available space in the shipping box 104 (see FIG. 1).

The artificial tree circulating apparatus also includes a base assembly 110 whose cutaway view is shown in FIG. 7. The base assembly 110 includes a blower unit 708 that when operating creates suction at one or more tube openings 710 of a tube 714. The tube 714 is to be coupled to a proximal opening of a conduit 704 that may form the artificial tree. The blower unit 708 may include an electrically driven fan that draws air into the assembly 110 and pushes the air through a flexible coupling 716 whose distal end is coupled to a proximal opening of the tube 714 as shown. The air is thus blown upwards thereby creating a suction effect at the opening 710. The blower unit 708 has sufficient blowing strength so that artificial snow particles can be sucked into the tube 714 through the one or more openings 710, and then blown through the conduit 704 and past its distal opening while the conduit is vertically oriented. The strength of the blowing unit 708 may be determined as a function of the height at the distal opening of the conduit 704, the size of the inner passage of the conduit 704 as well as the weight and shape of the artificial snow particles.

The tube 714 in the base assembly 110 in this embodiment is strong enough to support the conduit 704 in a vertical position, at the proximal opening of the conduit 704. Thus, in the embodiment shown in FIG. 7, the proximal opening of the conduit 704 slides onto and is held in a vertical position by a distal end of the tube 714. This tube 714 should be strong enough and be sufficiently supported such that it can withstand forces generated by the attachment of decorative elements to the conduit 704, such as an artificial tree that is built around the conduit 704.

The base assembly 110 further includes a first catch 720 that extends away from and surrounds the one or more tube openings 710. The first catch 720 serves to collect the particles that have fallen downwards after they have been blown past the distal opening of the conduit 704. In a particular embodiment, the first catch 720 is upwardly inclined as shown from the one or more tube openings 710. This allows the fallen particles to slide more easily downwards, towards the one or more tube openings 710.

To prevent the particles in the tube 714 from falling downwards and entering the blower unit 708, an air filter 724 is positioned inside the tube 714 and upstream of the one or more tube openings 710 as shown. Although in the embodiment shown in FIG. 7 the one or more tube openings 710 are a pair of opposing holes drilled into the wall of the tube 714, an alternative may be to create a true Venturi valve by forming the openings as tapered constrictions that cause an increase in the velocity of air flow and a corresponding decrease in pressure that is used for creating the suction. In one embodiment, to increase the air velocity so that suction power is increased, the distal end of the flex tube is constricted relative to the proximal portion of the flex tube.

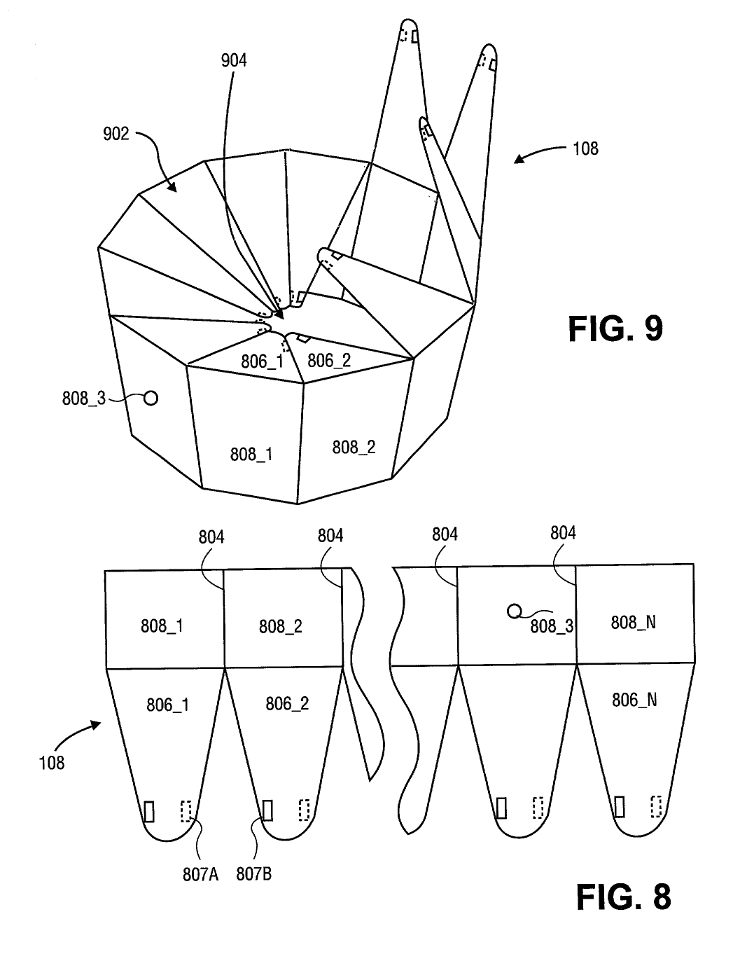

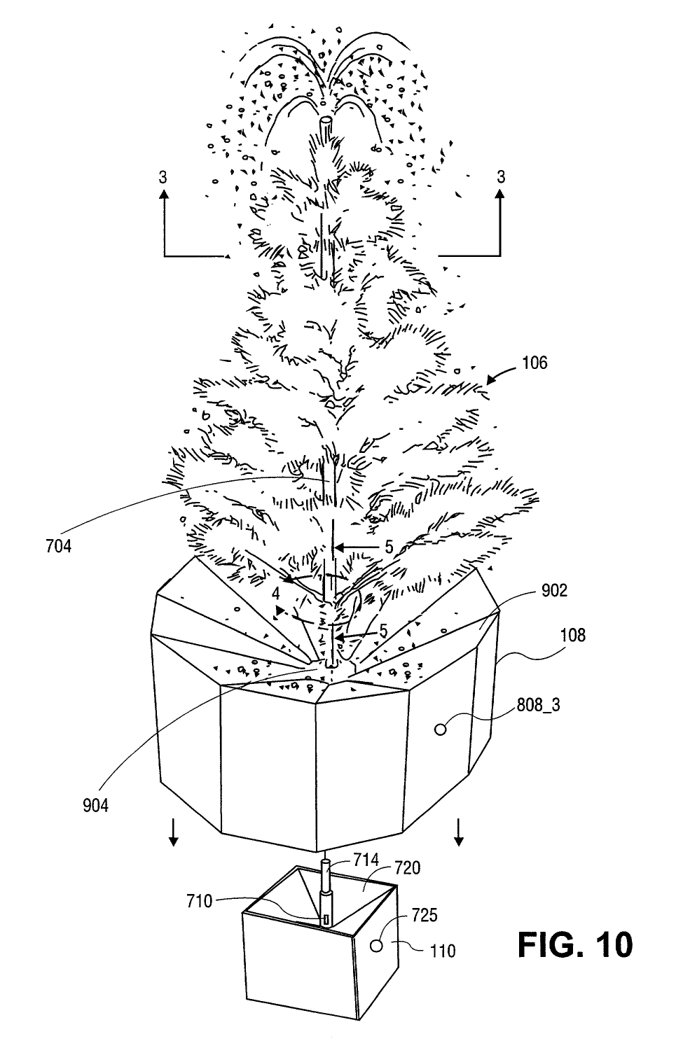

Referring now to FIG. 8, what's shown is a view of the drum 108 (see FIG. 1) as it has been unfolded. The drum is made of a number of connected sections where each section can pivot with respect to its adjacent section by means of, for instance, a living hinge 804. In this embodiment, the sections are relatively flat so that they can be folded on top of each other to form a stack as shown in FIG. 1. The drum 108 may be made up entirely of cardboard, although other materials may alternatively be used provided they permit the drum 108 to be folded into a stack. Each section has an upper portion 806 and a lower portion 808. Each upper portion 806 has a fastening mechanism which allows that upper portion to be removably attached to the upper portions of adjacent sections. For instance, upper portions 806_1 and 806_2 are removably attached to each other by the fastening mechanism pair 807a and 807b. This fastening mechanism pair may be a hook and loop fastener pair (e.g. VELCRO brand), where 807a is fixed on the bottom facing side of the section 806_1 while 807b is placed on the top facing side of the adjacent section 806_2. Fastening mechanisms other than the hook and loop fastener may alternatively be used. The two pieces of fastening mechanism are positioned such that the drum 108 may be assembled as shown in FIG. 9. The sections 808 and 806 as seen in this figure are arranged to form a closed catch 902 that has a central catch opening 904. In FIG. 9, one or more vents 808_3 are cut out in the vertical panels of the drum to insure air flow reaches box 110, in particular, the fan 708 (see FIG. 7) without obstruction. When assembled into this state, the drum 108 can be positioned over the base assembly 110 as shown in FIG. 10. The drum is positioned over the base assembly 110 with the catch opening 904 being located above and substantially coaxial with the first catch 720. With the second catch 902 being upwardly inclined from the catch opening 904 as shown, the fallen particles are permitted to slide downwards towards the catch opening 904. From there, the particles continue falling and are collected by the catch 720 and are then sucked into the tube openings and blown upwards through the conduit 704. In FIG. 10, additional air vents 725 are drilled in the side of the box 110 above ground level to insure that air enters the box free of any debris or snow that might collect around the box 110 and otherwise impede the operation of the fan 708.

To summarize, various embodiments of an artificial snow particle circulating apparatus have been described. In the foregoing specification, the invention has been described with reference to specific exemplary embodiments thereof. It will, however, be evident that various modifications and changes may be made thereto without departing from the broader spirit and scope of the invention as set forth in the appended claims. For instance, although the preferred embodiment shown is an artificial tree, wherein the decorative elements represent tree branches, other types of decorative displays may alternatively be built around the various embodiments of the conduit, base assembly, and drum described above. The specification and drawings are, accordingly, to be regarded in an illustrative rather than a restrictive sense.

What is claimed is:

1. An apparatus comprising:
a conduit having proximal and distal openings;
a base assembly having a blower unit to create suction at one or more tube openings of a tube that is to be coupled to the proximal opening of the conduit, the blower unit having sufficient blowing strength so that artificial snow particles can be sucked into the tube through the one or more tube openings and then blown through the conduit past the distal opening while the conduit is vertically oriented, the base assembly having a first catch that extends away from and surrounds the one or more tube openings, the first catch to collect the particles that have fallen downwards after the particles have been blown past the distal opening of the conduit; and
a drum having a plurality of connected sections, each section can pivot with respect to its adjacent sections so that the plurality of sections can be folded on top of each other to form a stack, each section having an upper portion and a lower portion, each upper portion having a fastening mechanism which allows that upper portion to be removably attached to the upper portions of adjacent sections to form a second catch having a catch opening, the drum to be positioned over the base assembly with the catch opening being located above and substantially coaxial with the first catch, and the second catch being upwardly inclined from the catch opening to allow the fallen particles to slide downwards towards the catch opening.

2. The apparatus of claim 1 wherein said conduit includes a first conduit portion having a first wall with an outer surface, the first conduit portion having open proximal and distant ends, a plurality of first decorative elements each being attached directly to the outer surface of the first wall, a second conduit portion having a second wall with an outer surface, the second conduit portion having open proximal and distant ends, a plurality of second decorative elements each being attached directly to the outer surface of the second wall, the open proximal end of the first conduit portion being adapted to be coupled to the open distal end of the second conduit portion to form said conduit.

3. The apparatus of claim 2 wherein the plurality of first and second decorative elements have the appearance of tree branches.

4. The apparatus of claim 3 wherein each of the plurality of first decorative elements has an end that is held against the outer surface of the first wall by tape that is wound a plurality of times around each end.

5. The apparatus of claim 3 wherein each of the plurality of second decorative elements has an end that pivotally coupled to a base, said base is directly attached to the outer surface of the second wall.

6. The apparatus of claim 1 wherein the tube in the base assembly is strong enough to support said conduit by itself, in a vertical position at the proximal opening of the conduit.

7. The apparatus of claim 6 further comprising an air filter positioned upstream of the one or more tube openings to prevent the particles in the tube from entering the blower unit.

8. The apparatus of claim 1 wherein the first catch is upwardly inclined from the one or more tube openings to allow the fallen particles to slide downwards towards the one or more tube openings.

9. The apparatus of claim 1 wherein the drum is made of cardboard.

10. The apparatus of claim 1 wherein the fastening mechanism on the drum includes at least one pair of hook and loop fasteners.

11. The apparatus of claim 1 wherein the conduit is made of metal.

12. An apparatus comprising:
a metal conduit having proximal and distal openings, wherein said conduit includes a first metal conduit portion having a first wall with an outer surface, the first conduit portion having open proximal and distant ends, a plurality of first decorative elements each being attached directly to the outer surface of the first wall, a second metal conduit portion having a second wall with an outer surface, the second conduit portion having open proximal and distant ends, a plurality of second decorative elements each being attached directly to the outer surface of the second wall, the open proximal end of the first conduit portion being adapted to be coupled to the open distal end of the second conduit portion to form said conduit;
a base assembly having a blower unit to create suction at one or more tube openings of a tube that is to be coupled to the proximal opening of the conduit, the blower unit having sufficient blowing strength so that artificial snow particles can be sucked into the tube through the one or more tube openings and then blown through the conduit past the distal opening while the conduit is vertically oriented, the base assembly having a first catch that extends away from and surrounds the one or more tube openings, the first catch to collect the particles that have fallen downwards after the particles have been blown past the distal opening of the conduit; and
a drum that forms a second catch having a catch opening, the drum to be positioned over the base assembly with the catch opening being located above and substantially coaxial with the first catch, and the second catch being upwardly inclined from the catch opening to allow the fallen particles to slide downwards towards the catch opening.

13. The apparatus of claim 12 wherein the plurality of first and second decorative elements have the appearance of tree branches.

14. The apparatus of claim 13 wherein each of the plurality of first decorative elements has an end that is held against the outer surface of the first wall by tape that is wound a plurality of times around each end.

15. The apparatus of claim 13 wherein each of the plurality of second decorative elements has an end that pivotally coupled to a base, said base is directly attached to the outer surface of the second wall.

16. The apparatus of claim 12 wherein the tube in the base assembly is strong enough to support said conduit by itself, in a vertical position at the proximal opening of the conduit.

17. The apparatus of claim 12 wherein the first catch is upwardly inclined from the one or more tube openings to allow the fallen particles to slide downwards towards the one or more tube openings.
